(19) United States
(12) Patent Application Publication
(10) Pub. No.: US 2026/0311327 A1
(43) Pub. Date: Oct. 8, 2026

(54) METHOD AND APPARATUS FOR IMAGING OF CELLS FOR THE QUANTITATIVE PHASE IMAGING OF CELLS

(71) Applicant: THRIVE BIOSCIENCE, INC., Beverly, MA (US)

(72) Inventors: Alan BLANCHARD, Beverly, MA (US); Kenneth CHAPMAN, Godley, TX (US); Frank EVANS, Portland, OR (US); Christian CHAPMAN, Cambridge, MA (US)

(21) Appl. No.: 19/481,964

(22) PCT Filed: May 6, 2024
(86) PCT No.: PCT/US2024/028011

§ 371 Date: Nov. 6, 2025

Related U.S. Application Data
(60) Provisional application No. 63/464,730, filed on May 8, 2023.

(51) Int. Cl. G06T 7/00; G02B 21/36

(52) U.S. Cl. CPC G06T 7/0012; G02B 21/367; G06T 2207/10056; G06T 2207/10148; G06T 2207/20056; G06T 2207/30024

(57) ABSTRACT

A method and apparatus for quantitative phase imaging a cell culture in a cell culture vessel has an imager for providing a plurality of z-stack brightfield images of at least a portion of the cell culture in the cell culture vessel, each image corresponding to a different focal distance relative to the cell culture and each image comprising an array of pixels and at least one processor configured to receive the plurality of z-stack brightfield images. The at least one processor processes the plurality of images to determine a plane of z which represents a central focal plane for the set of images, wherein the central focal plane has a z value, determines a polynomial function that estimates the intensities at each pixel location in each of the plurality of images as a function of z, creates an intensity image using polynomials from the polynomial function to create an image comprising an estimate of the physical intensity at each pixel of the image at the z value of the central focal plane, creates a first derivative image using polynomials from the polynomial function comprising an estimate of a first derivative of the physical intensity at each pixel of the image at the z value of the central focal plane, uses the intensity image and the first derivative image to define a three-dimensional voxel formed at each corresponding pixel in the intensity image and the first derivative image, each voxel having a base surface and a top surface and uses a transport of intensity equation to determine a phase distribution of each voxel and its surrounding voxels based on the estimates of the intensity and the first derivative to obtain a quantitative phase image of the cell culture.

### PRIORITY CLAIM

This application claims priority of U.S. Provisional Application Ser. No. 63/464,730, filed May 8, 2023, the entire contents of which are hereby incorporated herein by reference.

### FIELD OF THE INVENTION

The present invention relates to imaging methods and apparatus and in particular to the imaging of cell cultures.

### BACKGROUND

Cell culture incubators are used to grow and maintain cells from cell culture, which is the process by which cells are grown under controlled conditions. Cell culture vessels containing cells are stored within the incubator, which maintains conditions such as temperature and gas mixture that are suitable for cell growth. Cell imagers take images of individual or groups of cells for cell analysis.

While scientists use microscopes to observe cells during culturing and may also attach a camera to the microscope to image cells in a cell culture, such imaging systems have many disadvantages and are limited in the information they provide to the scientist.

### SUMMARY

The object of the present invention is to provide an improved imaging method and apparatus for the quantitative phase imaging of cells in a cell culture. An imaging method and apparatus for use herein is described in U.S. application Ser. No. 15/563,375 filed on Mar. 31, 2016, the disclosure of which in its entirety is hereby incorporated by reference.

Thrive Bioscience. Inc. the assignee hereof, provides methods and apparatus for illumination and capture of brightfield images. The current implementations of this hardware are called the CellAssist® and CellAssist®50 and can be used to carry out some embodiments of the invention. In addition to the CellAssist, examples of other embodiments of imagers capable for implementing embodiments of the present invention are disclosed in applications PCT/US22/45846 filed Oct. 6, 2022 and PCT/US23/11114 filed Jan. 19, 2023, the disclosures of which in their entirety are hereby incorporated by reference.

These and other objects of the present invention are achieved in some embodiments by a method for quantitative phase imaging a cell culture in a cell culture vessel, comprising the steps of providing a plurality of z-stack brightfield images of at least a portion of the cell culture in the cell culture vessel, each image corresponding to a different focal distance relative to the cell culture and each image comprising an array of pixels, processing the plurality of images to determine a plane of z which represents a central focal plane for the set of images, wherein the central focal plane has a z value, determining a polynomial function that estimates the intensities at each pixel location in each of the plurality of images as a function of z, creating an intensity image using polynomials from the polynomial function to create an image comprising an estimate of the physical intensity at each pixel of the image at the z value of the central focal plane, creating a first derivative image using polynomials from the polynomial function comprising an estimate of a first derivative of the physical intensity at each pixel of the image at the z value of the central focal plane, using the intensity image and the first derivative image to define a three-dimensional voxel formed at each corresponding pixel in the intensity image and the first derivative image, each voxel having a base surface and a top surface and using a transport of intensity equation to determine a phase distribution of each voxel and its surrounding voxels based on the estimates of the intensity and the first derivative to obtain a quantitative phase image of the cell culture.

In some embodiments of the method the cell culture is an adherent cell culture and wherein a uniform phase distribution at a pixel defines a floor of the cell culture wherein no cell is present.

In some embodiments of the method the cell culture is an adherent cell culture and wherein a non-uniform phase distribution at a pixel signifies the presence of a cell.

In some embodiments of the method each quantitative phase image is one of a plurality of image tiles which, when stitched together, form a quantitative phase image of the cell culture in the vessel.

In some embodiments of the method the processing, determining, creating and using steps are performed for every image tile.

In some embodiments of the method the transport of intensity equation is solved directly to provide phase distribution.

In some embodiments of the method the direct solving includes using Fourier transforms.

In some embodiments the transport of intensity equation is solved indirectly in an iterative manner to provide phase distribution.

In some embodiments of the method the step of determining a polynomial function that estimates the intensities at each such pixel location in each of the plurality of images comprises processing the images z-stack brightfield images using a least squares method to fit the intensities at each pixel in the plurality of images to determine the polynomial function that estimates the intensities at each such pixel location in each of the plurality of images, wherein a unique polynomial is generated, as a function of z.

These and other objects of the invention are also achieved in some embodiments in accordance with an apparatus for quantitative phase imaging a cell culture in a cell culture vessel having an imager for providing a plurality of z-stack brightfield images of at least a portion of the cell culture in the cell culture vessel, each image corresponding to a different focal distance relative to the cell culture and each image comprising an array of pixels and at least one processor configured to receive the plurality of z-stack brightfield images to process the plurality of images to determine a plane of z which represents a central focal plane for the set of images, wherein the central focal plane has a z value, determine a polynomial function that estimates the intensities at each pixel location in each of the plurality of images as a function of z, create an intensity image using polynomials from the polynomial function to create an image comprising an estimate of the physical intensity at each pixel of the image at the z value of the central focal plane, create a first derivative image using polynomials from the polynomial function comprising an estimate of a first derivative of the physical intensity at each pixel of the image at the z value of the central focal plane, use the intensity image and the first derivative image to define a three-dimensional voxel formed at each corresponding pixel in the intensity image and the first derivative image, each voxel having a base surface and a top surface, and use a transport of intensity equation to determine a phase distribution of each voxel and its surrounding voxels based on the estimates of the intensity and the first derivative to obtain a quantitative phase image of the cell culture.

In some embodiments of the apparatus the cell culture is an adherent cell culture and wherein a uniform phase distribution at a pixel defines a floor of the cell culture wherein no cell is present.

In some embodiments of the apparatus the cell culture is an adherent cell culture and wherein a non-uniform phase distribution at a pixel signifies the presence of a cell.

In some embodiments of the apparatus each quantitative phase image is one of a plurality of image tiles which, when stitched together, form a quantitative phase image of the cell culture in the vessel.

In some embodiments of the apparatus at least one processor processes z-stack brightfield images for every image tile.

In some embodiments of the apparatus the transport of intensity equation is solved directly to provide phase distribution.

In some embodiments of the apparatus the direct solving includes using Fourier transforms.

In some embodiments of the apparatus the transport of intensity equation is solved indirectly in an iterative manner to provide phase distribution.

In some embodiments of the apparatus determining a polynomial function that estimates the intensities at each such pixel location in each of the plurality of images comprises processing the images uses a least squares method to fit the intensities at each pixel in the plurality of images to determine the polynomial function that estimates the intensities at each such pixel location in each of the plurality of images, wherein a unique polynomial is generated, as a function of z.

These and other objects and advantages of the present invention will be explained in more detail with respect to the attached drawings wherein:

### BRIEF DESCRIPTION OF THE DRAWINGS

FIG. 1 is a block diagram of an apparatus for carrying out some embodiments of the method and apparatus of the invention;

FIG. 2A shows a typical well of a cell culture vessel;

FIG. 2B shows a top view of the tiling of images of the cell culture vessel well;

FIG. 3 shows the Z-stack of images for a single tile of FIG. 1B;

FIG. 4A shows the two lowest Z stack focal planes with one pixel highlighted;

FIG. 4B shows the voxel corresponding to the highlighted pixel in FIG. 3A;

FIG. 5 is a sample intensity image;

FIG. 6 is the QPI image corresponding to FIG. 4; and

FIG. 7 is a colorized version of the FIG. 5 image.

### DETAILED DESCRIPTION

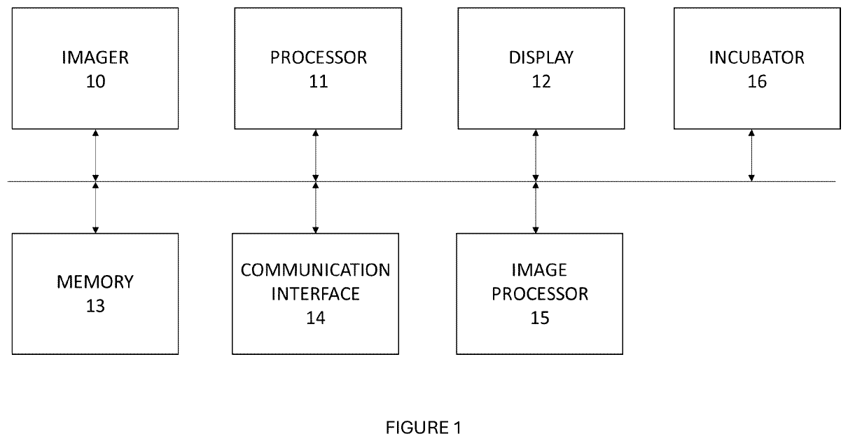

The apparatus in FIG. 1, which shows one embodiment of the present invention, includes an imager 10 and an incubator 16 run by processor 11 which is a microcontroller or microprocessor which has associated RAM and ROM memory 13 for storage of firmware and data. A connection through communication interface 14 allows connection to an external computer. The display 12 acts as a user interface and image processing can take place locally on image processor 15 or it can take place remotely using a more a powerful processor and more image storage to be available via the communication interface 14.

The imager is for example, the CellAssist which generates a stack of brightfield images covering a range of focus planes. This stack of images, referred to as a z-stack, enables processing the information in ways not available for a single image.

One such process allows for the selection of the best or central focus image. It also allows processing of above and below focus image pairs to find the best focal plane.

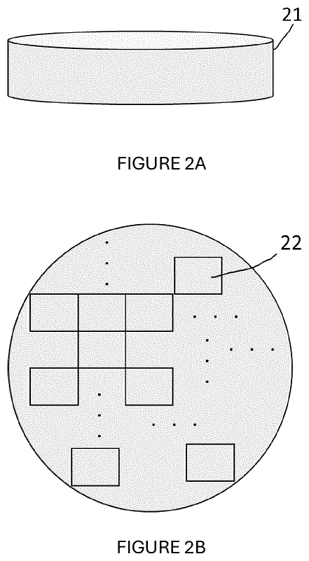

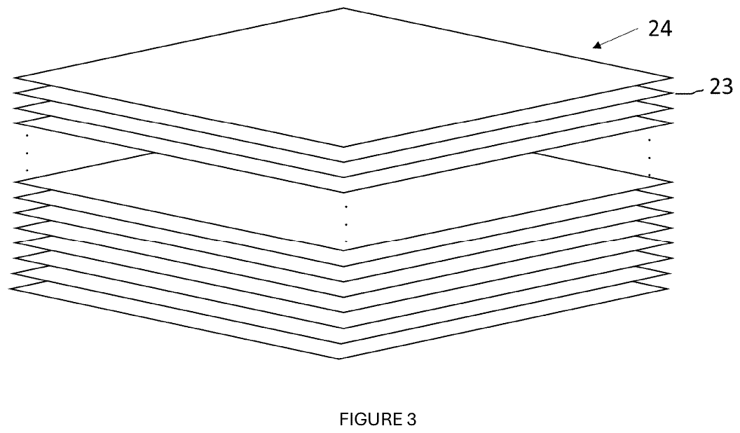

When the well 21 in FIG. 2A of the cell culture vessel is larger than the area imaged by the imager optics, the imager breaks up the image of the cell culture into a plurality of image tiles. FIG. 2B shows a number of tile images 22. The image processor then stitches the image tiles together to form an image of the culture in the whole well. This tiling of the image is performed in each z plane. FIG. 3 illustrates a z-stack 24 of tile images 23. The number of z planes can range from 4 to 100 in number per tile, or in some embodiments from 7-23.

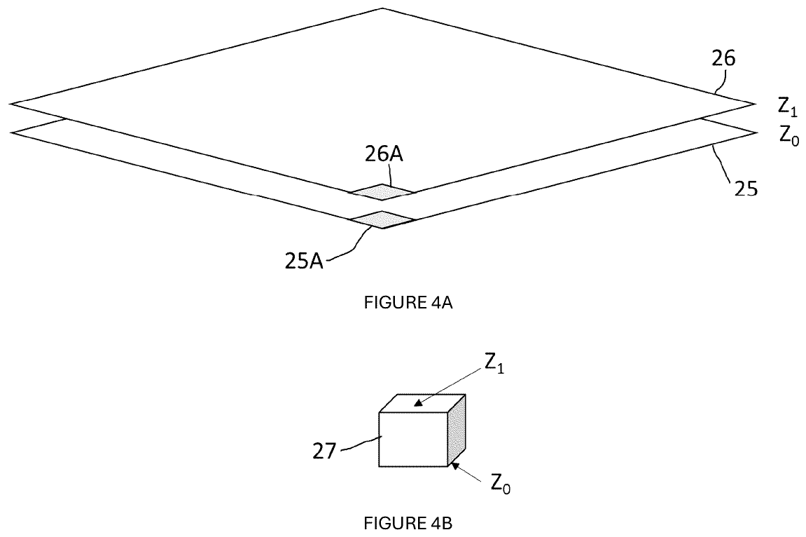

FIG. 4A shows two z planes z₀ and z₁ which are 25 and 26 respectively with one pixel 25A and 26A in each highlighted for purposes of discussion and which is not shown to scale. In a device like the CellAssist, the number of pixels is 1944×2592 which is approximately 5 megapixels in number. In FIG. 4B, the voxel 27 defined by the pixels in the two adjacent planes z₀ and z₁ is illustrated, also not to scale.

Illumination passes through a subject cells to a camera lens. “Below focus” describes a plane that is closer to the illuminator than the subject plane and “above focus” describes a plane that is farther away from the illuminator than the subject plane. The “best focus image” is the image of the subject plane.

In some embodiments, each whole well image is the result of the stitching together of a number of tiles. The number of tiles needed depend on the size of the well and the magnification of the camera objective. For example, a single well in a 6-well plate is the stitched result of 35 tiles from a 4× camera, 234 tiles from a 10× camera, or 875 tiles from a 20× camera.

The higher magnification objective cameras have smaller optical depth, that is, the z-height range in which an object is in focus. To achieve good focus at higher magnification, a smaller z-offset is preferred. As the magnification increases, the number of z-stack images increases or the working focal range decreases. If the number of z stack images increase, more resources are required to acquire the image, including time, memory and processing power. If the focal range decreases, the likelihood that the cell images will be out of focus is greater, due to instrument calibration accuracy, cell culture plate variation, well coatings, etc.

In some embodiments, the starting z-height value is determined by a database value assigned stored remotely or in local RAM. The z-height is a function of the cell culture plate type and manufacturer and is the same for all instruments and all wells. Any variation in the instruments, well plates, or coatings needs to be accommodated by a large number of z-stacks to ensure that the cells are in the range of focus adjustment. In practice this results in large imaging times and is intolerant to variation, especially for higher magnification objective cameras with smaller depth of field. For example, the 4× objective camera takes 5 z-stack images with a z-offset of 50 μm for a focal range of 5*50=250 μm. The 10× objective camera takes 11 z-stack images with a z-offset of 20 μm for a focal range of 11*20=220 μm. The 20× objective camera takes 11 z-stack images with a z-offset of 10 μm for a focal range of 11*10=110 μm.

Phase is an important component of an optical wavefield providing information on the refractive index, optical thickness, and the topology of the specimen. Phase retrieval is a challenge since the phase of a wavefield is not accessible directly. Phase contrast imaging adds complexity to an illumination system and requires careful selection of apertures to capture the edge changes of phase. In contrast, it is relatively easy to measure the intensity of the wavefield in a brightfield image.

The processing of brightfield z-stack images to extract the phase of the light at the focus plane is called a Quantitative Phase Image (QPI). The inventions described herein relate to embodiments of a method and apparatus that creates quantitative phase images that are obtained from brightfield images. The quantitative phase image can be used in order to obtain a better image of the cells, count cells, determine confluence and/or to classify cells.

Some embodiments of the present invention implement phase reconstruction using data in the z-stack of bright field intensity images. Having two (or more) plane measurements of intensity allows one to estimate the derivative of intensity in the z direction. The derivative in the z direction allows one to define a three-dimensional (3D) volume at each pixel, called a voxel. The voxel 27 in FIG. 4B defined by the pixels in the two adjacent planes z₀ and z₁ are used as an example.

Light flows into and out of this voxel and in accordance with some embodiments of the invention, we measure the intensity at the base XY surface and the top XY surface of the closed volume. Using the argument for the conservation of energy, in order for the intensity to increase or decrease from one XY surface of the voxel to the next XY surface, the light energy must be migrating into the other voxels in the local region. The mathematics of Green described in M. Reed Teague, “Deterministic phase retrieval: a Green's function solution,” J. Opt. Soc. Am. 73(11), 1434-1441 (1983), the entirety of the contents of which are incorporated by reference herein, explains this flux of energy as it traverses the closed boundary of voxels. These differential equations have a solution that enables the measurement of the phase of the brightfield light. This solution is known as a Transfer of Intensity Equation or TIE.

The commonly known transport of intensity equation (TIE) proposed by Teague is a non-interferometric method for retrieval of the optical phase. This equation provides a relationship between intensity and the phase of light propagating through the subject.

Boundary conditions and some assumptions about the illumination uniformity complicate the practical application of this TIE equation. Issues associated with non-phase related contrast and aperture effects have sometimes required that an iterative approach be applied. A good explanation of the iterative TIE-DCT (Discrete Cosine Transform) retrieval process is given in Zhong Jingshan, Rene A. Claus, Justin Dauwels, Lei Tian, and Laura Waller, “Transport of Intensity phase imaging by intensity spectrum fitting of exponentially spaced defocus planes”, OPTICS EXPRESS, 22(9) 10661-10674. (2014), the entirety of the contents of which are incorporated by reference herein. It focuses on the removal of the artifacts generated by an arbitrary aperture. However, in accordance with embodiments of the present invention, an accurate derivative estimate now allows solving the TIE directly to give the phase distribution, in a non-iterative manner using Fourier transform methods. This direct solution provides the phase relative to an indeterminate constant which is sufficient for many uses.

The general equation for TIE reconstruction is:

$$\frac{\partial I ( x , y )}{\partial z} = - \frac{λ}{2 π} \text{?} \cdot ( I ( x , y ) \text{?} φ ( x , y ) )$$

$$\text{?} \text{indicates text missing or illegible when filed}$$

When the intensity across the XY direction is uniform, only one solution is required. If non-phase intensity effects are to be handled, two solutions are needed. This is because the solution requires the boundary conditions (at the edge of the image). The uniform intensity assumption makes the boundary conditions known.

The solution selected in accordance with some embodiments of the present invention is a direct solution of the TIE equation and includes mitigation of the boundary condition issues. The solution utilizes Fourier transform methods which can perform the required gradient operations. The solution is guided by the method in C. Zuo, Q. Chen, and A. Asundi, “Boundary-artifact-free phase retrieval with the transport of intensity equation: fast solution with use of discrete cosine transform”, Optics Express 22(8), 9220-9244 (2014), the entirety of the contents of which are incorporated by reference herein.

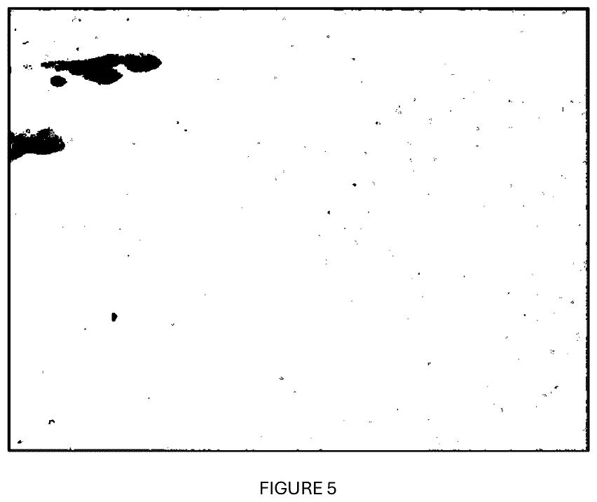

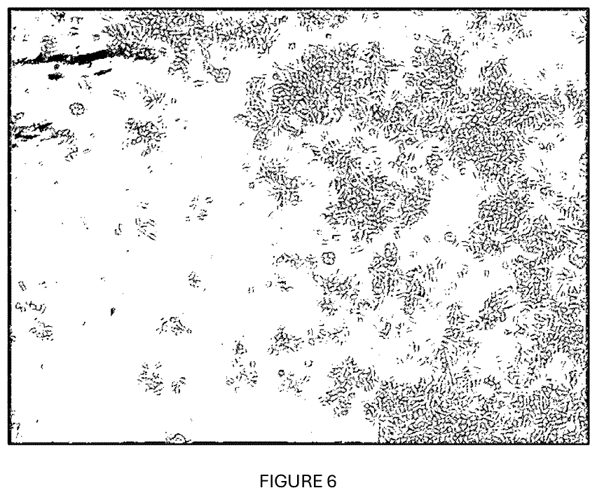

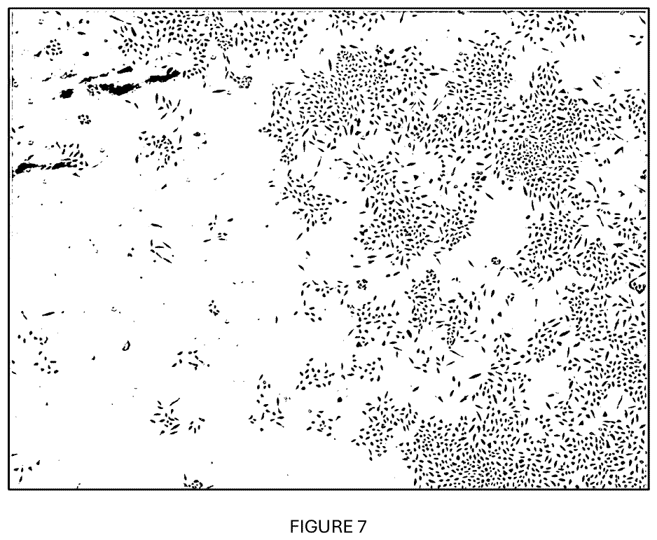

FIG. 5 is a sample intensity brightfield image of a cell culture. The results of the quantitative phase image (QPI) of this intensity brightfield image is shown in FIG. 6. FIG. 7 is a colorized version of the FIG. 6 image which makes the identification of cells even clearer.

The process in one embodiment for quantitative phase imaging a cell culture in a cell culture vessel, comprises the steps of:
a. providing a plurality of z-stack brightfield images of at least a portion of the cell culture in the cell culture vessel, each image corresponding to a different focal distance relative to the cell culture and each image comprising an array of pixels;
b. processing the plurality of images to determine a plane of z which represents a central focal plane for the set of images, wherein the central focal plane has a z value;
c. determining a polynomial function that estimates the intensities at each pixel location in each of the plurality of images as a function of z;
d. creating an intensity image using polynomials from the polynomial function to create an image comprising an estimate of the physical intensity at each pixel of the image at the z value of the central focal plane;
e. creating a first derivative image using polynomials from the polynomial function comprising an estimate of a first derivative of the physical intensity at each pixel of the image at the z value of the central focal plane;
f. using the intensity image and the first derivative image to define a three-dimensional voxel formed at each corresponding pixel in the intensity image and the first derivative image, each voxel having a base surface and a top surface; and
e. using a transport of intensity equation to determine a phase distribution of each voxel and its surrounding voxels based on the estimates of the intensity and the first derivative to obtain a quantitative phase image of the cell culture.

In some embodiments of the method the cell culture is an adherent cell culture and wherein a uniform phase distribution at a pixel defines a floor of the cell culture wherein no cell is present.

In some embodiments of the method the cell culture is an adherent cell culture and wherein a non-uniform phase distribution at a pixel signifies the presence of a cell.

In some embodiments of the method each quantitative phase image is one of a plurality of image tiles which, when stitched together, form a quantitative phase image of the cell culture in the vessel.

In some embodiments of the method the processing, determining, creating and using steps are performed for every image tile.

In some embodiments of the method the transport of intensity equation is solved directly to provide phase distribution.

In some embodiments of the method the direct solving includes using Fourier transforms.

In some embodiments of the method the transport of intensity equation is solved indirectly in an iterative manner to provide phase distribution.

In some embodiments of the method the step of determining a polynomial function that estimates the intensities at each such pixel location in each of the plurality of images comprises processing the images z-stack brightfield images using a least squares method to fit the intensities at each pixel in the plurality of images to determine the polynomial function that estimates the intensities at each such pixel location in each of the plurality of images, wherein a unique polynomial is generated, as a function of z.

As used herein, an “imager” refers to an imaging device for measuring light (e.g., transmitted or scattered light), color, morphology, or other detectable parameters such as a number of elements or a combination thereof. An imager may also be referred to as an imaging device. In certain embodiments, an imager includes one or more lenses, fibers, cameras (e.g., a charge-coupled device or CMOS camera), apertures, mirrors, light sources (e.g., a laser or lamp), or other optical elements. An imager may be a microscope. In some embodiments, the imager is a bright-field microscope.

As used herein, a “brightfield microscope” or “brightfield imager” is an imager that illuminates a sample and produces an image based on the light absorbed by or passing through the sample. Any appropriate bright-field microscope may be used in combination with an incubator provided herein. In some embodiments, the imager is outside of an incubator such as with the CellAssist, or an incubator cabinet includes a single imager as in the CellAssist50.

In some embodiments, an incubator cabinet includes two imagers.

Alternatively, the apparatus in some embodiments can include a display device such as a tablet mounted on one face of the system and the apparatus can operate as a self-contained unit.

In some embodiments, the image processing is either on board or external, has algorithms for artificial intelligence and intelligent image analysis. The image processing permits trend analysis and forecasting, documentation and reporting, live/dead cell counts, confluence percentage and growth rates, cell distribution and morphology changes, and the percentage of differentiation.

In some embodiments, one or more imaging systems may be interconnected by one or more networks in any suitable form, including as a local area network (LAN) or a wide area network (WAN) such as an enterprise network or the Internet. Such networks may be based on any suitable technology and may operate according to any suitable protocol and may include wireless networks, wired networks, or fiber optic networks.

When the imager is fully encased with the incubator, the interior of the imager can be set at 98.6 degrees F.° with a CO₂ content of 5%, so that the cells can remain in the imager without damage. The temperature and the CO₂ content of the air in the apparatus can be maintained by a gas feed. Alternatively, a heating unit can be installed in the apparatus to maintain the proper temperature. In some embodiments, the apparatus can also be connected to a computer or tablet for data input and output and for the control of the system. The connection can be by way of an ethernet connector or a USB connector.

In some embodiments, the imaging apparatus and method described herein can be used as a stand-alone imaging system or it can be integrated in a cell incubator using a transport described in the aforementioned application incorporated by reference. In some embodiments, the imaging system and method is integrated in a cell incubator and includes a transport.

In some embodiments the apparatus and method acquire data and images at the times a cell culturist typically examines cells. In some embodiments, the method and apparatus provide objective data, images, guidance and documentation that improves cell culture process monitoring and decision-making.

The apparatus and method in some embodiments enable sharing of best practices across labs, assured repeatability of process across operators and sites, traceability of process and quality control. In some embodiments the method and apparatus provide quantitative measures of cell doubling rates, documentation and recording of cell morphology, distribution and heterogeneity.

In some embodiments, the method and apparatus provide assurance that cell lines are treated consistently and that conditions and outcomes are tracked. Leveraging this database of observations, researchers are able to profile cell growth, test predictions and hypotheses concerning cell conditions, media and other factors affecting cell metabolism, and determine whether cells are behaving consistently and/or changing.

In some embodiments the method and apparatus enable routine and accurate cell counting and/or confluence measurements and imaging and enables biologists to quantify responses to stimulus or intervention, such as the administration of a therapeutic to a cell line.

The method and apparatus in some embodiments will capture the entire well area with higher coverage than conventional images and enables the highest level of statistical rigor for quantifying cell status and distribution.

In some embodiments, the method and apparatus provide additional image processing and algorithms that will deliver an integration of individual and group morphologies with process-flow information and biological outcomes. Full well imaging allows the analysis and modeling of features of groups of cells which are conducive to modeling organizational structures in biological development. These capabilities can be used for prediction of the organizational tendency of culture in advance of functional testing.

In some embodiments, algorithms are used to separate organizational patterns between samples using frequency of local slope field inversions. Using some algorithms, the method and system can statistically distinguish key observed differences between iP-MSCs generated from different TCP conditions. Biologically, this work could validate serum-free differentiation methods for iPSC MSC differentiation. Computationally, the method and apparatus can inform image-processing of MSCs in ways that less neatly “clustered” image sets are not as qualified to do. In some embodiments the method and apparatus described herein can be used to image IVF cells and tissue.

Even if all iP-MSC conditions have a sub-population of cells that meets ISCT 7-marker criteria, the “true MSC” sub-populations may occupy a different proportion under different conditions or fate differences could be implied by tissue “meso-structures”. By starting with a rich pallet of MSC outcomes, and grounding them in comparative biological truth, the method and apparatus can refine characterization perspectives around this complex cell type and improve MSC bioprocess.

As noted, cell cultures are composed of media, cells, and debris. The cells are volumes of protoplasm confined by a cell membrane into a compact region within the surrounding media. The optical properties of the protoplasm differ from the optical properties of the media. The media usually has a lower index of refraction than the cell contents, but the techniques described here can be easily adapted to the opposite relationship. The debris is frequently the residue of cells that have died and this confounds normal search techniques that seek to identify the living cells. In some embodiments the method and apparatus rely on the fact that the living cells have an intact surface membrane that continues to confine the internal content within a compact region.

The compact region, given sufficient space in the media, will pull itself into rounded shapes. These shapes, composed of fluids with a higher index of refraction, cause the rays of the illumination to be diverted toward the center of each such region much like a positive lens diverts light. This converges the illumination rays to create an image of increased brightness in a plane above the subject plane (above focus). In addition, if the camera lens is focused on a plane which is below the subject plane, the rays which would otherwise be available to image that plane “behind the compact region” have been diverted, creating a region of low brightness roughly in the shape of the compact region (below focus).

As cells are pushed together and touch each other as they grow, the boundaries tend to widen and appear as if they are not parts of the cells when they really are. To accommodate this, in some embodiments all non-cell areas are identified and their area is calculated. Related to the area between cells, an area threshold is defined based on a fixed area threshold, or a dynamic area threshold based on cell size, overall image confluence, neighborhood confluence and/or other measures. If the area between cells is below the threshold, that area is determined to be part of a cell or touching cells.

In some embodiments, each of the candidate cells are evaluated by their shape, color (or intensity), texture, contour features, etc. to determine whether they are really cells or if they are debris.

In some embodiments, all the areas defined as cells as a fraction of the total area where it is possible to grow cells are calculated as the confluence. In some embodiments, based upon cell type and density, we measure confluence in very confluent areas using one type of measuring method and in the less confluent areas we use a different type of measuring method. When we move away from the in-focus image in either direction, the size and shape of the bright/dark areas around the cells change in size. A dynamic method here would be to evaluate the size and shape of those dark/bright areas based on the expected size/shape for the cells of interest. When we move away from the in-focus image in either direction, the brightness/color/texture of the dark and light areas change depending on distance from focus. A dynamic method here would be to evaluate the brightness/color/texture of those dark/bright areas based on the expected brightness/color/texture for the cells of interest.

In some embodiments, a further step in the process includes alerting the user of the method and apparatus that confluence has reached a preselected value and that an action has to be taken such as passaging. In some embodiments, the steps above are used to perform cell counting.

As noted, the apparatus and method in some embodiments enable sharing of best practices across labs, assured repeatability of process across operators and sites, traceability of process and quality control. In some embodiments the method and system provide quantitative measures of cell doubling rates, documentation and recording of cell morphology, distribution and heterogeneity.

The apparatus and method in some embodiments capture the entire well area with higher coverage than conventional images and enables the highest level of statistical rigor for quantifying cell status and distribution.

In some embodiments, a further step in the process includes alerting the user of the method and apparatus that confluence has reached a preselected value and that an action has to be taken such as passaging. In some embodiments, the steps above are used to perform cell counting.

In some cases, operations such as controlling, operations of a cell culture incubator and/or components such as an imager provided therein or interfacing therewith, controlling the imager and components thereof, controlling a database and image processing, may be implemented using hardware, software or a combination thereof. When implemented in software, the software code can be executed on any suitable processor or collection of processors, whether provided in a single component or distributed among multiple components. Such processors may be implemented as integrated circuits with one or more processors in an integrated circuit component. The processor may be implemented using circuitry in any suitable format.

In some embodiments, a component (e.g., a controller) controls various processes performed inside the incubator, imager and image processing apparatus. For example, a controller may direct control equipment (e.g, a manipulator, an imager, a fluid handling, system. etc.). In some embodiments, the controller controls imaging of cell cultures, picking of cells. weeding of cells (e.g., removal of cell clumps) monitoring of cell culture conditions, adjustment of cell culture conditions, tracking of cell culture vessel movement within the incubator, comparing images, storing images maintaining a database and/or scheduling of any of the foregoing processes.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention.

More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used.

Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed.

The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, e.g., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (e.g. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, e.g., to mean including but not limited to.

Only the transitional phrases “consisting of” and “consisting essentially of” shall be closed or semi-closed transitional phrases, respectively, as set forth in the United States Patent Office Manual of Patent Examining Procedures, Section 2111.03.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

It should also be understood that, unless clearly indicated to the contrary, in any methods claimed herein that include more than one step or act, the order of the steps or acts of the method is not necessarily limited to the order in which the steps or acts of the method are recited.

What is claimed is:

1. A method for quantitative phase imaging a cell culture in a cell culture vessel, comprising the steps of:
a. providing a plurality of z-stack brightfield images of at least a portion of the cell culture in the cell culture vessel, each image corresponding to a different focal distance relative to the cell culture and each image comprising an array of pixels;
b. processing the plurality of images to determine a plane of z which represents a central focal plane for the set of images, wherein the central focal plane has a z value;
c. determining a polynomial function that estimates the intensities at each pixel location in each of the plurality of images as a function of z;
d. creating an intensity image using polynomials from the polynomial function to create an image comprising an estimate of the physical intensity at each pixel of the image at the z value of the central focal plane;
e. creating a first derivative image using polynomials from the polynomial function comprising an estimate of a first derivative of the physical intensity at each pixel of the image at the z value of the central focal plane;
f. using the intensity image and the first derivative image to define a three-dimensional voxel formed at each corresponding pixel in the intensity image and the first derivative image, each voxel having a base surface and a top surface; and
e. using a transport of intensity equation to determine a phase distribution of each voxel and its surrounding voxels based on the estimates of the intensity and the first derivative to obtain a quantitative phase image of the cell culture.

2. The method according to claim 1, wherein the cell culture is an adherent cell culture and wherein a uniform phase distribution at a pixel defines a floor of the cell culture wherein no cell is present.

3. The method according to claim 1, wherein the cell culture is an adherent cell culture and wherein a non-uniform phase distribution at a pixel signifies the presence of a cell.

4. The method according to claim 1, wherein each quantitative phase image is one of a plurality of image tiles which, when stitched together, form a quantitative phase image of the cell culture in the vessel.

5. The method according to claim 4, wherein steps a. through f. are performed for every image tile.

6. The method according to claim 1, wherein the transport of intensity equation is solved directly to provide phase distribution.

7. The method according to claim 6, wherein the direct solving includes using Fourier transforms.

8. The method according to claim 1, wherein the transport of intensity equation is solved indirectly in an iterative manner to provide phase distribution.

9. The method according to claim 1, wherein the step of determining a polynomial function that estimates the intensities at each such pixel location in each of the plurality of images comprises processing the images z-stack brightfield images using a least squares method to fit the intensities at each pixel in the plurality of images to determine the polynomial function that estimates the intensities at each such pixel location in each of the plurality of images, wherein a unique polynomial is generated, as a function of z.

10. An apparatus for quantitative phase imaging a cell culture in a cell culture vessel, comprising:
an imager for providing a plurality of z-stack brightfield images of at least a portion of the cell culture in the cell culture vessel, each image corresponding to a different focal distance relative to the cell culture and each image comprising an array of pixels; and
at least one processor configured to receive the plurality of z-stack brightfield images to
process the plurality of images to determine a plane of z which represents a central focal plane for the set of images, wherein the central focal plane has a z value; determine a polynomial function that estimates the intensities at each pixel location in each of the plurality of images as a function of z;
create an intensity image using polynomials from the polynomial function to create an image comprising an estimate of the physical intensity at each pixel of the image at the z value of the central focal plane;
create a first derivative image using polynomials from the polynomial function comprising an estimate of a first derivative of the physical intensity at each pixel of the image at the z value of the central focal plane;
use the intensity image and the first derivative image to define a three-dimensional voxel formed at each corresponding pixel in the intensity image and the first derivative image, each voxel having a base surface and a top surface; and
use a transport of intensity equation to determine a phase distribution of each voxel and its surrounding voxels based on the estimates of the intensity and the first derivative to obtain a quantitative phase image of the cell culture.

11. The apparatus according to claim 10, wherein the cell culture is an adherent cell culture and wherein a uniform phase distribution at a pixel defines a floor of the cell culture wherein no cell is present.

12. The apparatus according to claim 10, wherein the cell culture is an adherent cell culture and wherein a non-uniform phase distribution at a pixel signifies the presence of a cell.

13. The apparatus according to claim 10, wherein each quantitative phase image is one of a plurality of image tiles which, when stitched together, form a quantitative phase image of the cell culture in the vessel.

14. The apparatus according to claim 13, wherein at least one processor processes z-stack brightfield images for every image tile.

15. The apparatus according to claim 10, wherein the transport of intensity equation is solved directly to provide phase distribution.

16. The apparatus according to claim 15, wherein the direct solving includes using Fourier transforms.

17. The apparatus according to claim 10, wherein the transport of intensity equation is solved indirectly in an iterative manner to provide phase distribution.

18. The apparatus according to claim 10, wherein determining a polynomial function that estimates the intensities at each such pixel location in each of the plurality of images comprises processing the images uses a least squares method to fit the intensities at each pixel in the plurality of images to determine the polynomial function that estimates the intensities at each such pixel location in each of the plurality of images, wherein a unique polynomial is generated, as a function of z.
